(19) United States
(12) Patent Application Publication
(10) Pub. No.: US 2025/0145750 A1
(43) Pub. Date: May 8, 2025

(54) Paraffinic Process Oil For EPDM Rubber Products

(71) Applicant: ExxonMobil Technology and Engineering Company, Spring, TX (US)

(72) Inventors: Eric P. Jourdain, Rhode Saint Genese (BE); Meha H. Shah, Easton, PA (US); Elumalai Jayaraman, Channasandra (IN); Bernard D'Cruz, Whitefield, (IN); Serge Riffard, Spring, TX (US); Scott H. Loyd, Annandale, NJ (US); Sunny Jacob, Annandale, NJ (US); Rugved P. Pathare, Pittstown, NJ (US)

(73) Assignee: ExxonMobil Technology and Engineering Company, Spring, TX (US)

(21) Appl. No.: 18/932,780

(22) Filed: Oct. 31, 2024

Related U.S. Application Data
(60) Provisional application No. 63/595,662, filed on Nov. 2, 2023.

(51) Int. Cl. C08F 236/04; C08F 236/20; C08K 5/01

(52) U.S. Cl. CPC C08F 236/045; C08F 236/20; C08K 5/01

(57) ABSTRACT

A method for using a saturated paraffinic process oil may include: curing an ethylene-propylene-diene-monomer (EPDM) composition to form an EPDM article, wherein the EPDM composition comprises EPDM rubber and a saturated paraffinic process oil, wherein the saturated paraffinic process oil comprises: a kinematic viscosity at 100° C. in a range of 14 cSt to 45 cSt; a sulfur content of less than 0.03 wt. %; a saturates content of at least 90 wt. %; a T5 distillation point of at least 480° C.; an aniline point in a range of about 130° C. to about 150° C.; a refractive index at 20° C. in a range of 1.460-1.490; and a sum of terminal/pendant propyl groups and terminal/pendant ethyl groups of at least 1.7 per 100 carbon atoms of the composition

### FIELD

The present disclosure relates to ethylene-propylene-diene-monomer (EPDM) rubber, and more particularly to EPDM compositions produced with a paraffinic process oil.

### BACKGROUND

Ethylene Propylene Diene Monomer (EPDM) rubber, also known as Ethylene Propylene Diene PolyMethylene rubber, is one of the most important general purpose synthetic rubbers. EPDM rubbers have desirable material properties including exceptional aging, weathering, and fogging characteristics, as well as resistance to oxygen, ozone, and UV. The favorable properties and stability of EPDM arise in part due to the saturated ethylene-propylene backbone of EPDM polymer strands as well as crosslinking between the polymer strands. EPDM has many applications in industry, including automotive weather stripping, seals, sealant, wire harnesses, and bumpers, in construction as weatherproofing, roofing sheets, expansion joints, garage door seals, and tank liners, and in industrial uses such as O-rings, hoses, gaskets, diaphragms, grommets, and belts, for example.

EPDM polymer may be produced from the reaction of ethylene monomer, propylene monomer, and a diene monomer, typically hexadiene, ethylidene norbornene (ENB) and/or dicyclopentadiene (DCPD), to produce a terpolymer of EPDM. EPDM can be produced by several different processes including gas phase polymerization, slurry polymerization, and solution polymerization.

A rubber article manufacturer will typically blend the EPDM polymer with fillers, additives, and a process oil to form a mixture which can be molded and shaped to form the desired part such as sheets, hoses, gaskets, and the like. Process oils used in EPDM production include paraffinic mineral oils with a specified viscosity and aromatics content. The process oil functions as a plasticizer for the EPDM allowing for the components to be blended as well as providing desired mechanical properties and weathering performance to the final rubber article. The parts are then cured under sulfur or peroxide conditions to crosslink the pendant diene groups in the EPDM to form the final manufactured part.

### SUMMARY

Disclosed herein is an example method for using a saturated paraffinic process oil including: curing an ethylene-propylene-diene-monomer (EPDM) composition to form an EPDM article, wherein the EPDM composition comprises EPDM rubber and a saturated paraffinic process oil, wherein the saturated paraffinic process oil comprises: a kinematic viscosity at 100° C. in a range of 14 cSt to 45 cSt; a sulfur content of less than 0.03 wt. %; a saturates content of at least 90 wt. %; a T5 distillation point of at least 480° C.; an aniline point in a range of about 130° C. to about 150° C.; a refractive index at 20° C. in a range of 1.460-1.490; and a sum of terminal/pendant propyl groups and terminal/pendant ethyl groups of at least 1.7 per 100 carbon atoms of the composition.

Further disclosed herein is an example composition comprising: cured EPDM; and a saturated paraffinic process oil having: a kinematic viscosity at 100° C. of at least 14 cSt; a sulfur content of less than 0.03 wt. %; a saturates content of at least 90 wt. %; a T5 distillation point of at least 480° C.; an aniline point in a range of about 130° C. to about 150° C.; a refractive index at 20° C. in a range of 1.470-1.490; and a sum of terminal/pendant propyl groups and terminal/pendant ethyl groups of at least 1.7 per 100 carbon atoms of the composition.

Further disclosed herein is a method including: polymerizing ethylene, propylene, and a diene containing monomer to form ethylene-propylene-diene-monomer (EPDM) rubber; and mixing the EPDM rubber with a saturated paraffinic process oil, wherein the saturated paraffinic process oil has: a kinematic viscosity at 100° C. of at least 14 cSt; a sulfur content of less than 0.03 wt. %; a saturates content of at least 90 wt. %; a T5 distillation point of at least 480° C.; an aniline point in a range of about 130° C. to about 150° C.; a refractive index at 20° C. in a range of 1.470-1.490; and a sum of terminal/pendant propyl groups and terminal/pendant ethyl groups of at least 1.7 per 100 carbon atoms of the composition.

These and other features and attributes of the disclosed methods and compositions of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 is a graph of results of Mooney Viscosity for EPDM compounds produced in accordance with some embodiments of the present disclosure.

FIG. 2 is a graph of results of tensile strength after hot air aging for EPDM compounds produced in accordance with some embodiments of the present disclosure.

FIG. 3 is a graph of results of change in elongation at break after hot air aging for EPDM compounds produced in accordance with some embodiments of the present disclosure.

FIG. 4 is an MDR curve of EPDM compounds produced in accordance with some embodiments of the present disclosure.

FIG. 5 is a graph of results of change in mechanical properties after weathering of EPDM compounds produced in accordance with some embodiments of the present disclosure.

FIG. 6 is a graph of results of UV aging in a weatherometer of EPDM compounds produced in accordance with some embodiments of the present disclosure.

FIG. 7 is a graph of results of UV aging in a weatherometer of EPDM compounds produced in accordance with some embodiments of the present disclosure.

FIG. 8 is an MDR curve of EPDM compounds produced in accordance with some embodiments of the present disclosure.

FIG. 9 is a graph of results of Mooney Viscosity for EPDM compounds produced in accordance with some embodiments of the present disclosure.

FIG. 10 is a graph of Shore A hardness for EPDM compounds produced in accordance with some embodiments of the present disclosure.

FIG. 11 is a graph of change in tensile strength for EPDM compounds and hot air aged EPDM compounds produced in accordance with some embodiments of the present disclosure.

FIG. 12 is a graph of change in elongation breaking for EPDM compounds and hot air aged EPDM compounds produced in accordance with some embodiments of the present disclosure.

FIG. 13 is a graph of change in energy at breaking for EPDM compounds and hot air aged EPDM compounds produced in accordance with some embodiments of the present disclosure.

FIG. 14 is a graph of change in compression set for hot air aged EPDM compounds produced in accordance with some embodiments of the present disclosure.

### DETAILED DESCRIPTION

The present disclosure relates to elastomer compositions produced with a high viscosity saturated paraffinic process oil. Some embodiments include ethylene-propylene-diene-monomer (EPDM) rubber produced with a high viscosity saturated paraffinic process oil. The saturated high viscosity saturated paraffinic process oil described herein provides an EPDM rubber with improved properties compared to EPDM rubber produced with a conventional paraffinic process oil of medium viscosity (10-13 cSt at 100° C.) or high viscosity (>30 cSt at 100° C.). The disclosed EPDM compositions have improved physical properties, mechanical properties, improved fogging properties, lower cure rates, and improved weathering performance and improved temperature aging, as compared to conventionally produced EPDM compositions. The paraffinic process oil of the present disclosure is a saturated high viscosity paraffinic process oil having a viscosity of greater than 14 cSt at 100° C. and low aromatic content

In the rubber industry, process oils are used to reduce viscosity and improve processability of EPDM compositions. Process oils also promote filler dispersion, lower hardness, lower glass transition temperature, increase chain flexibility, weathering, and aging, among other properties in the final cured rubber product. Process oils that are used are mostly petroleum or coal-based chemicals with relatively lower molecular weights that include paraffinic, naphthenic, and aromatic carbon compositions. One attribute of EPDM rubber is the capability to compound the rubber with a relatively large amount of filler and oil. However, the high molecular weight and viscosity of EPDM combined with large amount of filler can result in poor processability of the rubber product which may require a relatively large quantity of process oil.

### Definitions and Test Methods

All numerical values within the detailed description and the claims herein are modified by “about” or “approximately” with respect to the indicated value, and take into account experimental error and variations that would be expected by a person having ordinary skill in the art. Unless otherwise indicated, ambient temperature (room temperature or “RT”) is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure and the claims thereto, the following definitions shall be used.

As used herein, “kinematic viscosity at 100° C.” will be used interchangeably with “KV100” and “kinematic viscosity at 40° C.” will be used interchangeably with “KV40.” In embodiments, kinematic viscosity KV100 and/or KV40 is measured according to ASTM D 445-21.

Aromatic fractions and saturate fractions in process oils are determined according to ASTM D7419-18 (2018).

Mooney Viscosity, Mooney Stress-Relaxation, and Pre-Vulcanization Characteristics such as incipient cure (scorch time) (Mooney Scorch), and Mooney relaxation area are measured using a Mooney viscometer, operated according to ASTM D1646-19a. As used herein, Mooney viscosity is reported using the format: Rotor ([pre-heat time, min.]+[shearing time, min.]@measurement temperature, ° C.), such that ML (1+4 @100° C.) indicates a Mooney viscosity determined using the ML or large rotor according to ASTM D1646-19a, for a pre-heat time of 1 minute and a shear time of 4 minutes, at a temperature of 100° C. Mooney scorch times are reported using the format: Rotor ([pre-heat time, min.]+[shearing time, min.]@measurement temperature, ° C.), such that ML (1+60 @125° C.) indicates a Mooney viscosity determined using the ML or large rotor according to ASTM D1646-19a, for a pre-heat time of 1 minute and a shear time of 60 minutes, at a temperature of 125° C. Mooney scorch times are reported as T2 and T5 which are indicators of processability nature of rubber compounds with a higher time indicating better processability. T2 is the time required to increase the torque by 2 units from minimum torque in the money scorch test and T5 is the time required to increase the torque by 5 units from minimum torque in the money scorch test.

Moving die rheometers (MDR), operated according to ASTM D 5289-19a, produce MDR rheometric curves which describe physical properties of elastomers. Typical values from ASTM D 5289-19a include MI, initial torque, it is the torque recorded at time zero at the start of the test. ML, minimum torque, as the elastomer heats under pressure, the viscosity decreases and the torque decreases. The lowest registered torque value is called ML and is a measure of the rigidity and viscosity of the non-vulcanized compound. MH, maximum torque, is maximum torque from curing. Time values such TS1 and TS2 are values after reaching the minimum torque during the curing phase the torque is increased, TS1 or TS2 is the induction time for the viscosity to increase 1 or 2 units above ML. Additional values include tc50 (50% cure time), is the moment when 50% cross-linking has been reached and tc90 (90% cure time), it is the moment in which 90% cross-linking has been reached.

Shore A and D hardness are determined according to ASTM D2240-15(2021).

Tensile and elongation properties are determined according to ASTM D412-16(2021).

Boiling ranges are determined according to ASTM D6352-19e1 (2020).

Aniline point is determined according to ASTM D611-12(2016).

Paraffinic carbon (Cp), aromatics content (Ca), and naphthenic carbon content (Cn) as measured by ASTM D2140.

Refractive index is determined according to ASTM D1218.

### Paraffinic Process Oil

In embodiments, a paraffinic process oil is used in production of EPDM rubber and EPDM compositions. The paraffinic process oil of the present disclosure is a saturated high viscosity paraffinic process oil characterized as having a viscosity of greater than 14 cSt at 100° C. and an aromatic content of less than 10 wt. % aromatic hydrocarbons. The saturated high viscosity paraffinic process oil comprises saturated hydrocarbon compounds in an amount ≥90% by weight, sulfur in an amount ≤0.03% by weight, and has a KV100 in a range of 14-45. Alternatively, the saturated high viscosity paraffinic process oil has a KV100 in a range of 14-45, or 30-40, or 32-38, or any sub ranges therebetween. Alternatively, the saturated high viscosity paraffinic process oil has a saturates content as measured by ASTM D7419-18 of greater than 90 wt. %, or greater than 95 wt. %, or greater than 98 wt. %, or greater than 99 wt. %, or greater than 99.5 wt. %.

In embodiments, the saturated high viscosity paraffinic process oil has a T5 distillation point (i.e. the temperature where 5% of the oil is distilled) of at least 480° C. as measured by ASTM D6352. Alternatively, the saturated high viscosity paraffinic process oil has a T5 distillation point of at least 500° C. In embodiment, the saturated high viscosity paraffinic process oil has a T5 distillation point in a range of 480° C. to 505° C.

In embodiments, the saturated high viscosity paraffinic process oil contains sulfur in an amount less than 0.03% by weight. Alternatively, the saturated high viscosity paraffinic process oil contains sulfur in an amount less than 0.02% by weight or less than 0.01% by weight.

In addition, detailed characterization of the branching of the molecules by 13C-NMR reveals a high degree of branch points as described further below in the examples. This can be quantified by examining the absolute number of methyl branches, or ethyl branches, or propyl branches individually or as combinations thereof. This can also be quantified by looking at the ratio of branch points (methyl, ethyl, or propyl) compared to the number of internal carbons, labeled as epsilon carbons by 13C-NMR. For 13C-NMR results reported herein, samples were prepared to be 25-30 wt. % in CDCl3 with 7% Chromium (III)-acetylacetonate added as a relaxation agent. 13C NMR experiments were performed on a JEOL ECS NMR spectrometer for which the proton resonance frequency is 400 MHz. Quantitative 13C NMR experiments were performed at 27° C. using an inverse gated decoupling experiment with a 450 flip angle, 6.6 seconds between pulses, 64 K data points and 2400 scans. All spectra were referenced to TMS at 0 ppm. Spectra were processed with 0.2-1 Hz of line broadening and baseline correction was applied prior to manual integration. The entire spectrum was integrated to determine the mole % of the different integrated areas as follows: 170-190 PPM (aromatic C); 30-29.5 PPM (epsilon carbons); 15-14.5 PPM (terminal and pendant propyl groups) 14.5-14 PPM-Methyl at the end of a long chain (alpha); 12-10 PPM (pendant and terminal ethyl groups). Total methyl content was obtained from proton NMR. The methyl signal at 0-1.1 PPM was integrated. The entire spectrum was integrated to determine the mole % of methyls. Average carbon numbers obtained from gas chromatography were used to convert mole % methyls to total methyls.

In various aspects, the saturated high viscosity paraffinic process oil used in the compositions and methods disclosed herein include a total number of terminal/pendant propyl groups greater than 0.85, or greater than 0.86, or greater than 0.90 per 100 carbon atoms; they show a total number of ethyl groups greater than 0.85, or greater than 0.88, or greater than 0.90, or greater than 0.93, or greater than 0.95 per 100 carbon atoms. For example, the sum of the terminal/pendant propyl and ethyl groups is greater than 1.7, or 1.75, or 1.8, or 1.85, or 1.9 per 100 carbon atoms.

In embodiments the saturated high viscosity paraffinic process oil has a total number of terminal/pendant propyl groups is greater than 0.86 per 100 carbon atoms of the composition.

In embodiments the saturated high viscosity paraffinic process oil has a total number of terminal/pendant ethyl groups is greater than 0.88 per 100 carbon atoms of the composition.

In embodiments the saturated high viscosity paraffinic process oil has a ratio of terminal/pendant propyl groups to epsilon carbon atoms of at least 0.063.

In embodiments the saturated high viscosity paraffinic process oil has a ratio of terminal/pendant ethyl groups to epsilon carbon atoms of at least 0.064.

In embodiments the saturated high viscosity paraffinic process oil has a ratio of a sum of terminal/pendant propyl groups and terminal/pendant ethyl groups to epsilon carbon atoms of at least 0.13.

In embodiments, the saturated high viscosity paraffinic process oil has a total number of terminal/pendant propyl groups is greater than 0.86 per 100 carbon atoms of the composition, or wherein a total number of terminal/pendant ethyl groups is greater than 0.88 per 100 carbon atoms of the composition.

In embodiments the saturated high viscosity paraffinic process oil has a ratio of a sum of terminal/pendant propyl groups and terminal/pendant ethyl groups to epsilon carbon atoms of at least 0.10.

In various aspects, saturated high viscosity paraffinic process oil used in the compositions and methods disclosed herein the total number of propyl and ethyl groups relative to epsilon carbon atoms is greater than 0.127, or greater than 0.130, or greater than 0.133, or greater than 0.140, or greater than 0.150 or greater than 0.160. In embodiments, the ratio of propyl groups to epsilon carbon atoms is greater than 0.063 or greater than 0.065, and the ratio of ethyl groups to epsilon carbon atoms is greater than 0.064, or greater than 0.065, or greater than 0.068, or greater than 0.070, respectively. In embodiments, the ratio of alpha carbons to the sum of propyl and ethyl groups is less than 1.36, or less than 1.3, or less than 1.25, or less than 1.24.

In various aspects, saturated high viscosity paraffinic process oil used in the compositions and methods disclosed herein have at least 20% (i.e., at least 20 molecules per 100 molecules of the composition) of 2-ring cycloparaffins; at least 22% (i.e., at least 22 molecules per 100 molecules of the composition) of 3-ring cycloparaffins; less than 13.5% (i.e., less than 13.5 molecules per 100 molecules of the composition) of 5-ring cycloparaffins; and less than 8.5%/o (i.e., less than 8.5 molecules per 100 molecules of the composition), or less than 8.0 molecules per 100 molecules, or less than 7.0 molecules per 100 molecules, of 6-ring cycloparaffins. Comparing the ratio of 1, 2, and 3 ring cycloparaffins to 4, 5, and 6 ring cycloparaffins,

For FDMS (Field Desorption Mass Spectrometry) results reported herein, Field desorption (FD) is a soft ionization method in which a high-potential electric field is applied to an emitter (a filament from which tiny “whiskers” have formed) that has been coated with a diluted sample resulting in the ionization of gaseous molecules of the analyte. Mass spectra produced by FD are dominated by molecular radical cations M+ or in some cases protonated molecular ions [M+H]+. Because FDMS cannot distinguish between molecules with ‘n’ naphthene rings and molecules with ‘n+7’ rings, the FDMS data was “corrected” by using the FTICR-MS data from the most similar sample. The FDMS correction was performed by applying the resolved ratio of “n” to “n+7” rings from the FTICR-MS to the unresolved FDMS data for that particular class of molecules.

In embodiments the saturated high viscosity paraffinic process oil has as determined by FDMS at least 17 molecules including 2 saturated rings per 100 molecules and at least 20 molecules including 3 saturated rings per 100 molecules.

In embodiments, the saturated high viscosity paraffinic process oil have an aniline point as measured by ASTM D611 in a range of 130° C. to 150° C. Alternatively, the saturated high viscosity paraffinic process oil have an aniline point as measured by ASTM D611 at a point in a range of from 130° C. to 135° C., 135° C. to 140° C., 140° C. to 145° C., 145° C. to 150° C., or any ranges therebetween.

In embodiments, the saturated high viscosity paraffinic process oil have a paraffinic carbon (Cp) as measured by ASTM D2140, in an amount of 70 wt. % to 99.9 wt. %. Alternatively, the par saturated high viscosity paraffinic process oil have a paraffinic carbon (Cp) of 70 wt. % to 80 wt. %, 80 wt. % to 90 wt. %, 90 wt. % to 99 wt. %, 99 wt. % to 99.9 wt. %, or any ranges therebetween.

In embodiments, the saturated high viscosity paraffinic process oil have a naphthenic carbon content (Cn), as measured by ASTM D2140, in an amount of 70 wt. % to 99 wt. %. Alternatively, the saturated high viscosity paraffinic process oil have a paraffinic carbon (Cp) of 70 wt. % to 80 wt. %, 80 wt. % to 90 wt. %, 90 wt. % to 99 wt. %, or any ranges therebetween.

In embodiments, the saturated high viscosity paraffinic process oil have an aromatics content (Ca), as measured by ASTM D2140 in an amount of 10 wt. % or less. Alternatively, the saturated high viscosity paraffinic process oil have an aromatics content (Ca) of 5 wt. % or less, 3 wt. % or less, 1 wt. % or less, 0.5 wt. % or less, or 0.1 wt. % or less.

In embodiments, the saturated high viscosity paraffinic process oil have a refractive index at 20° C. as measured by ASTM D1218 in a range of 1.460-1.490. Alternatively, from 1.460-1.470, from 1.470-1.475, from 1.475-1.480, 1.480-1.485, 1.485-1.490, or any ranges therebetween.

### Elastomer Composition

In embodiments, the elastomer composition includes an elastomer and a high viscosity saturated paraffinic process oil. Suitable elastomers for inclusion in the elastomer composition include, but are not limited to olefinic elastomeric copolymers, butyl rubber, natural rubber, styrene-butadiene copolymer rubber, butadiene rubber, acrylonitrile rubber, butadiene-styrene-vinyl pyridine rubber, urethane rubber, polyisoprene rubber, epichlorohydrin terpolymer rubber, polychloroprene, and mixtures thereof. In one or more embodiments, olefinic elastomeric copolymers include ethylene-propylene rubbers, propylene-based rubbery copolymers, and ethylene-based plastomers. The term ethylene-propylene rubber refers to rubbery copolymers polymerized from ethylene, at least one α-olefin monomer, and optionally at least one diene monomer. The α-olefins may include, but are not limited to, propylene, 1-butene, 1-hexene, 4-methyl-1-pentene, 1-octene, 1-decene, or combinations thereof. In one embodiment, the α-olefins include propylene, 1-hexene, 1-octene or combinations thereof. The diene monomers may include, but are not limited to, 5-ethylidene-2-norbornene; 5-vinyl-2-norbornene; divinyl benzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. In the event that the copolymer is prepared from ethylene, α-olefin, and diene monomers, the copolymer may be referred to as a terpolymer or even a tetrapolymer in the event that multiple α-olefins or dienes are used.

In embodiments, the elastomer composition includes an EPDM polymer produced from the reaction of ethylene monomer, propylene monomer, and a diene monomer, to produce a terpolymer of EPDM. EPDM can be produced by several different processes including gas phase polymerization, slurry polymerization, and solution polymerization. In embodiment, EPDM rubbers are produced by Ziegler polymerization of the double bond in vinyl norbornene which produces a highly branched ethylene, α-olefin, vinyl norbornene elastomeric polymer. Ziegler polymerization of the double bond in vinyl norbornene permits the production of elastomeric polymers substantially free of gel which would normally be associated with cationically branched ethylene, α-olefin, non-conjugated diene elastomeric polymer containing, for instance, a non-conjugated diene such as 5-ethylidene-2-norbornene (ENB), and/or 1,4-hexadiene. In further embodiments, the diene monomer includes at least one of hexadiene, ethylidene norbornene (ENB) dicyclopentadiene (DCPD), and/or vinyl norbornene.

In another embodiment, the EPDM polymer produced herein is a copolymer of 1) ethylene; 2) up to 80 mol % (preferably from 30 mol % to 80 mol %, preferably from 40 mol % to 70 mol %) of one or more C₃ to C₄₀ (preferably C₃ to C₂₀, preferably C₃ to C₁₂) olefins, preferably alpha-olefins (preferably propylene, 1-butene, 1-hexene, and 1-octene); and 3) oligomers (preferably present at 30 mol %, or less, more preferably 20 mol % or less, even more preferably 15 mol % or less).

In embodiments, the EPDM polymer is oil extended with the saturated high viscosity paraffinic process oil. Oil extension is typically accomplished by mixing the EPDM polymer exiting the reactor while the EPDM polymer is still in a slurry phase. In embodiments, the EPDM polymer is extended with process oil in an amount of 1 wt. % to 100 wt. % by weight of the EPDM polymer. The extender oil is be blended with the EPDM polymer in a post-polymerization reactor. The introduction of the oil takes place after the reactor but before the removal of volatiles, for example before a steam stripper. To achieve good mixing, the extender oil is often blended with the EPDM polymer when the EPDM polymer is still dissolved or suspended in the reaction medium exiting the polymerization reactor. The amount of extender oil added depends on the molecular weight of the ethylene elastomer and the end use. In the case of EPDM, extender oils are typically added to reduce the apparent viscosity to less than about 100 mu (Mooney units). In embodiments, EPDM compositions include 1 phr to 200 phr extender oil. For high modulus applications, the EPDM typically contains from about 50 to about 125 phr (parts per hundred resin) of extender oil.

In one embodiment, the oil extended ethylene alpha-olefin or ethylene alpha-olefin and diene copolymers can be copolymerized with at least one diene monomer to create cross-linkable copolymers. Suitable diene monomers include any hydrocarbon structure, preferably C₄ to C₃₀, having at least two unsaturated bonds. Preferably the diene is a non-conjugated diene with at least two unsaturated bonds, wherein one of the unsaturated bonds is readily incorporated into a polymer. The second bond may partially take part in polymerization to form cross-linked polymers but normally provides at least some unsaturated bonds in the polymer product suitable for subsequent functionalization (such as with maleic acid or maleic anhydride), curing or vulcanization in post polymerization processes. Examples of dienes include, but are not limited to butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, and polybutadienes having a molecular weight (M_{w}) of less than 1000 g/mol. Examples of straight chain acyclic dienes include, but are not limited to 1,4-hexadiene and 1,6-octadiene. Examples of branched chain acyclic dienes include, but are not limited to 5-methyl-1,4-hexadiene, 3,7-dimethyl-1,6-octadiene, and 3,7-dimethyl-1,7-octadiene. Examples of single ring alicyclic dienes include, but are not limited to 1,4-cyclohexadiene, 1,5-cyclooctadiene, and 1,7-cyclododecadiene. Examples of multi-ring alicyclic fused and bridged ring dienes include, but are not limited to tetrahydroindene; methyl-tetrahydroindene; dicyclopentadiene; bicyclo-(2.2.1)-hepta-2,5-diene; 2,5-norbornadiene; and alkenyl-, alkylidene-, cycloalkenyl-, and cylcoalkyliene norbornenes [including, e.g., 5-methylene-2-norbornene, 5-ethylidene-2-norbornene (ENB), 5-propenyl-2-norbornene, 5-isopropylidene-2-norbornene, 5-(4-cyclopentenyl)-2-norbornene, 5-cyclohexylidene-2-norbornene, and 5-vinyl-2-norbornene]. Examples of cycloalkenyl-substituted alkenes include, but are not limited to vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. 5-ethylidene-2-norbornene (ENB) is a preferred diene in particular embodiments.

Diene monomers as utilized in some embodiments have at least two polymerizable unsaturated bonds that can readily be incorporated into polymers to form cross-linked polymers in a polymerization reactor. A polymerizable bond of a diene is referred as to a bond which can be incorporated or inserted into a polymer chain during the polymerization process of a growing chain. Diene incorporation is often catalyst specific. For polymerization using metallocene catalysts, examples of such dienes include α,ω-dienes (such as butadiene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, and 1,13-tetradecadiene) and certain multi-ring alicyclic fused and bridged ring dienes (such as tetrahydroindene; 7-oxanorbornadiene, dicyclopentadiene; bicyclo-(2.2.1)-hepta-2,5-diene; 5-vinyl-2-norbornene; 3,7-dimethyl-1,7-octadiene; 1,4-cyclohexadiene; 1,5-cyclooctadiene; 1,7-cyclododecadiene and vinyl cyclohexene). In one embodiment of polymer compositions (and/or processes for making them), the content of diene with at least two polymerizable bonds in the inventive polymer composition is less than 0.5 wt. %, preferably less than 0.1 wt. % of the copolymer.

In embodiments, EPDM polymers are produced using catalysts including VCl₄ (vanadium tetrachloride) and/or VOCl₅ (vanadium oxytrichloride). In embodiments, a co-catalyst is included wherein the co-catalyst is selected from (i) ethyl aluminum sesqui chloride (SESQUI), (ii) diethyl aluminum chloride (DEAC) and (iii) a 4/1 molar mixture of diethyl aluminum chloride to triethyl aluminum TEAL). In embodiments, the components of the EPDM polymer and catalyst/co-catalyst are introduced into a continuous stirred tank reactor at reaction conditions to produce the EPDM polymer. Suitable polymerization conditions include a temperature in a range of 20-65° C., residence times of 6-15 minutes, and a pressure of 7-12 kg/cm². In embodiments, the molar concentration of vanadium to alkyl is from 1 to 4 to 1 to 10. In embodiments, about 0.3 to 1.5 kg of polymer is produced per gram of catalyst fed to the reactor. A typical polymer concentration in the hexane solvent is in the range of 3-7% by weight.

As used herein the terms “EPDM polymer”, “ethylene elastomers” are intended to mean ethylene and alpha-olefin or ethylene, alpha-olefin and diene copolymers. In one embodiment, the oil extended EPDM polymer comprises ethylene, an alpha-olefin, and incorporated olefin oligomers. Optionally, the oil extended EPDM polymer further comprises one or more diene-derived units.

The alpha-olefin in the oil extended ethylene alpha-olefin or ethylene alpha-olefin and diene copolymers can be selected from C₃ to C₄₀ alpha-olefins. Preferably the alpha-olefins have 3 to 12 carbon atoms such as propylene, 1-butene, 1-pentene, 3-methyl-1-butene, 1-hexene, 3-methyl-1-pentene, 4-methyl-1-pentene, 3-ethyl-1-pentene, 1-octene, 1-decene, 1-undecene (two or more of which may be employed in combination). Among those listed above, propylene is more preferred. Preferably, the copolymer produced herein is a copolymer of ethylene, propylene, and oligomers or a copolymer of ethylene, propylene, diene and oligomers.

In yet further embodiments, the EPDM polymer compositions may also or instead be characterized by their composition. In some general embodiments, the polymer compositions may be said to comprise units derived from one or more, two or more, or three or more C₂-C₄₀ alpha-olefins (or C₂-C₂₀ alpha-olefins, or C₂-C₁₂ alpha-olefins), and optionally one or more dienes. For instance, the polymer compositions may comprise units derived from ethylene, one or more C₃-C₁₂ alpha-olefins, and optionally one or more dienes.

In embodiments where an EPDM polymer may be characterized as having ethylene content in an amount ranging from about 20 to about 80 (or alternatively, e.g., from any one of about 20, 25, 30, 35, and 40, to any one of about 45, 50, 55, 60, 65, 70, 75, and 80) wt. %, on the basis of the total weight of copolymers in the copolymer composition. When such compositions further include dienes, they may be present in amounts ranging from about 0.3 to about 15 (or alternatively, e.g., from any one of about 0.3, 0.5, 0.7, and 1 to any one of about 2, 3, 4, 5, 6, 7, 8, 9, 10, 11, 12, 13, 14, and 15) wt. %, on the basis of the total weight of copolymers in the copolymer composition.

The EPDM polymer in some embodiments comprises one or more EPDM polymers (a blend of two or more EPDM polymers), each EPDM polymer comprising units derived from two or more different C₂-C₁₂ alpha-olefins, oligomers and, optionally, one or more dienes.

Such EPDM polymer compositions may further be characterized as comprising one or more copolymers, each copolymer having units derived from ethylene in an amount ranging from about 20 to about 80 (or, alternatively, from any one of about 20, 25, 30, 35, and 40, to any one of about 45, 50, 55, 60, 65, 70, 75, and 80) wt. %, on the basis of the total weight of the copolymer. When such a copolymer includes dienes, the dienes may be present in amounts ranging from about 0.3 to about 15 (or e.g., from any one of about 0.3, 0.5, 0.7, and 1 to any one of about 2, 3, 4, 5, 6, 7, 8, 9, 10, 11, 12, 13, 14, and 15) wt. %, based on the total weight of the copolymer. The fraction of each EPDM polymer can be determined using fractionation techniques as known by one of skill in the art.

In embodiments, the EPDM polymer includes a polymerized product of ethylene monomer, propylene monomer, and one or more diene monomers. In embodiments, diene monomers used in preparing EPDM rubber include conjugated or non-conjugated, straight or branched chain-, cyclic- or polycyclic-dienes containing from 4 to 20 carbons. In embodiments, dienes include 1,4-pentadiene, 1,4-hexadiene, 5-ethylidene-2-norbornene, dicyclopentadiene, cyclohexadiene, and 5-butylidene-2-norbornene. In embodiments, the resulting product comprises isotactic homopolymer segments alternating with elastomeric copolymer segments, made in situ during the polymerization. In embodiments, the EPDM polymer includes the ethylene monomer in an amount of 1 wt. % to 99 wt. %. Alternatively, in certain embodiments, in an amount of 1 wt. % to 10 wt. %, 10 wt. % to 25 wt. %, 25 wt. % to 50 wt. %, 50 wt. % to 75 wt. %, 75 wt. % to 99 wt. %, or any ranges therebetween. In embodiments, the EPDM polymer includes the propylene monomer in an amount of 1 wt. % to 99 wt. %. Alternatively, in certain embodiments, in an amount of 1 wt. % to 10 wt. %, 10 wt. % to 25 wt. %, 25 wt. % to 50 wt. %, 50 wt. % to 75 wt. %, 75 wt. % to 99 wt. %, or any ranges therebetween. In embodiments, the EPDM polymer includes the one or more diene monomers in an amount of 0.1 wt. % to 25 wt. %. Alternatively, in certain embodiments, in an amount of 0.1 wt. % to 1 wt. %, 1 wt. % to 10 wt. %, 10 wt. % to 15 wt. %, 15 wt. % to 20 wt. %, 20 wt. % to 25 wt. %, or any ranges therebetween. In embodiments, the EPDM polymer includes polymers with a weight average molecular weight (Mw) from 10,000 to about 3,000,000. Alternatively, in certain embodiments, from 10,000 to 50,000, from 50,000 to 100,000, from 100,000 to 500,000, from 500,000 to 1,000,000, from 1,000,000 to 2,000,000, from 2,000,000 to 3,000,000, or any ranges there between.

### Methods of Making Elastomer Compositions

Elastomer compositions of the present disclosure include an elastomer and a saturated high viscosity paraffinic process oil. In further embodiments, the elastomer includes an oil extended elastomer. Elastomer compositions may further include compounding agents, including, but not limited to elastomeric copolymers, strengthening agents, fillers, vulcanization agents, cross-linking agents, vulcanization accelerators, vulcanization retarders, softeners, processing aids, antioxidants, ultraviolet absorbers, blowing agents, lubricants, pigments, colorants, dispersants, and flame retardants, for example. In embodiments, the elastomer composition is prepared by mixing the elastomer and saturated high viscosity paraffinic process oil, as well as any compounding agents, such as a cross-linking agents. In embodiments, the elastomer compositions are formed to a desired shape and be further cured or vulcanized to form an cured rubber article.

The elastomer composition according to various embodiments includes the saturated high viscosity paraffinic process oil in an amount of 5 wt. % to 50 wt. % based on a total weight of the elastomer composition. Alternatively, in certain embodiments, it includes the saturated high viscosity paraffinic process oil in an amount from 5 wt. % to 10 wt. %, 10 wt. % to 25 wt. %, 25 wt. % to 50 wt. %, or any ranges therebetween.

In embodiments, the elastomer compositions further include one or more additives including, but not limited to, carbon black, amorphous precipitated or fumed silica, titanium dioxide, polyethylene glycol, calcium oxide, magnesium oxide, colored pigments, clay, talc, calcium carbonate, magnesium carbonate, aluminum silicates, wollastonite, mica, montmorillonite, glass beads, hollow glass spheres, glass fibers, plastic fibers, zinc oxide and stearic acid and salts thereof, stabilizers, antidegradants, flame retardants, processing aids, adhesives, tackifiers, plasticizers, wax, discontinuous fibers, such as wood cellulose fibers and combinations thereof. In embodiments, the elastomer compositions include one or more additives in an amount of 1 wt. % to 99 wt. % by total weight of the EPDM composition. Alternatively, in certain embodiments, in an amount of 1 wt. % to 10 wt. %, 10 wt. % to 25 wt. %, 25 wt. % to 50 wt. %, 50 wt. % to 75 wt. %, 75 wt. % to 99 wt. %, or any ranges therebetween.

In embodiments, the elastomer compositions further include a sulfur curing agent which is capable of curing (vulcanizing) the elastomer composition. Suitable classes of sulfur curing agents include, but are not limited to, elemental sulfur in atomic, oligomeric, cyclic and/or polymeric state as well as sulfur-containing compounds, such as thiazoles, imidazoles, sulfenamides, thiuram disulfides, 2,2′-Dithiobis(benzothiazole) (MBTS), substituted dithiocarbamates, benzothiazole sulfenamide, 2-Mercaptobenzothiazole (MBT), and combinations thereof. The EPDM compositions may include the sulfur curing agent in an amount of 0.001 wt. % to 2 wt. %. by total weight of the EPDM composition. Alternatively, in certain embodiments, in an amount of 0.001 wt. % to 0.01 wt. %, 0.01 wt. % 0.1 wt. %, 0.1 wt. % to 1 wt. %, 1 wt. % to 1.5 wt. %, 1.5 wt. % to 2 wt. %, or any ranges therebetween.

In embodiments, the elastomer compositions further include a peroxide curing agent which is capable of curing the elastomer composition. Suitable classes peroxide curing agents include, but are not limited to, dicumyl peroxide, di-tert-butyl peroxide, and combinations thereof. The elastomer compositions may include the peroxide curing agent in an amount of 0.001 wt. % to 2 wt. %. by total weight of the EPDM composition. Alternatively, in certain embodiments, in an amount of 0.001 wt. % to 0.01 wt. %, 0.01 wt. % 0.1 wt. %, 0.1 wt. % to 1 wt. %, 1 wt. % to 1.5 wt. %, 1.5 wt. % to 2 wt. %, or any ranges therebetween.

In embodiments, co-agents may be used with either the sulfur and/or peroxide curing agents. Co-agents may include type I co-agents and type II co-agents such as multifunctional acrylate and methacrylate esters and dimaleimides, zinc salts of acrylic and methacrylic acid, allyl-containing cyanurates, isocyanurates and phthalates, homopolymers of dienes, and co-polymers of dienes and vinyl aromatics. Some examples of specific co-agents include, but are not limited to, paraquinonedioxime, dibenzoparaquinonedioxime, 4,4′-Dithiodimorpholine, phenolic resin, trimethylolpropane trimethacrylate, azides, aldehyde-amine reaction products, vinyl silane grafted moieties, hydrosilylation, substituted ureas, substituted guanidines; substituted xanthates; zinc dibenzyldithiocarbamate (ZBEC), and combinations thereof.

In embodiments, the elastomer compositions are further cured to form a cured rubber article.

In embodiments, the elastomer compositions are prepared in any suitable manner for mixing rubbery polymers including mixing on a rubber mill or in internal mixers such as a Banbury mixer. In embodiments, the curing of the elastomer composition to form the cured rubber article be carried out by any suitable methods including dynamic and static vulcanization techniques.

### EPDM Product Properties

In embodiments, the elastomer includes an EPDM rubber. The EPDM products prepared from the vulcanization of the EPDM compositions containing saturated high viscosity paraffinic process oil of the present disclosure have better physical properties as compared to EPDM produced with conventional high viscosity paraffinic process oils, including better weathering and fogging resistance in SAE and ASTM testing as well as improved mechanical properties, accelerated aging, color stability (sulfur bloom), cross link density, and filler distribution.

In embodiments, the EPDM product has a Mooney Viscosity ML(1+4) @100° C. value in a range of 60 to 85. Alternatively, in certain embodiments, a Mooney Viscosity ML(1+4) @100° C. value in a range of 60 to 70, 70 to 80, 80 to 85, or any ranges therebetween.

In embodiments, the EPDM product has a T2 Mooney Scorch ML(1+60) @125° C. value in a range of 3.5 to 8.5. Alternatively, in certain embodiments, from 3.5 to 5, 5 to 7, 7 to 8.5, or any ranges therebetween.

In embodiments, the EPDM product has a T5 Mooney Scorch ML(1+60) @125° C. value in a range of 4 to 9.5. Alternatively, in certain embodiments, from, 4 to 6, 6 to 8, 8 to 9.5, or any ranges therebetween.

In embodiments, the EPDM product has an ML, MH, TS2, and TC 90 values as measured by a moving die rheometer (MDR). In embodiments, the EPDM product has properties as measured by a MDR 160° C./60 mins including an ML value in a range of 1.2 to 3, or alternatively, in certain embodiments, from 17.6 to 18, 18 to 18.5, 18.5 to 19.2, or any ranges therebetween, a TS2 value in a range of 0.4-0.5 minutes, and a TC90 value in a range of 3.2 to 4.2 minutes. In embodiments, the EPDM product has a hardness in Shore A of 66-72, or alternatively, in certain embodiments, 66-68, 68-70, 70-72, or any ranges therebetween.

### EPDM Product End Uses

Non-limiting examples of rubber articles produced from vulcanization of the EPDM compositions disclosed herein may include automotive body parts (e.g., deck lids, hoods, front end, bumpers, doors, chassis components, suspension components), articles such as tires, hoses, belts, gaskets, moldings and molded parts. EPDM compositions disclosed herein are particularly useful for applications that require high melt strength such as large part blow molding, foams, and wire cables.

### Thermoplastic Olefins (TPO) Containing EPDM Product

In embodiments, a thermoplastic olefin (TPO) is produced using the EPDM composition disclosed herein. TPO embodiments include a thermoplastic such as polypropylene, polyethylene, and/or derivatives thereof, the EPDM composition which may be oil extended, and optional additives such as stabilizers to protect against heat and UV degradation, fillers including as talc, calcium carbonate, or glass fibers for reinforcement, processing aids, antioxidants, and other performance-enhancing chemicals.

### Additional Embodiments

Accordingly, the present disclosure relates to methods of making EPDM compositions, and more particularly to methods may include any of the various features disclosed herein, including one or more of the following embodiments.

Embodiment 1. A method for using a saturated paraffinic process oil comprising: curing an ethylene-propylene-diene-monomer (EPDM) composition to form an EPDM article, wherein the EPDM composition comprises EPDM rubber and a saturated paraffinic process oil, wherein the saturated paraffinic process oil comprises: a kinematic viscosity at 100° C. in a range of 14 cSt to 45 cSt; a sulfur content of less than 0.03 wt. %; a saturates content of at least 90 wt. %; a T5 distillation point of at least 480° C.; an aniline point in a range of about 130° C. to about 150° C.; a refractive index at 20° C. in a range of 1.460-1.490; and a sum of terminal/pendant propyl groups and terminal/pendant ethyl groups of at least 1.7 per 100 carbon atoms of the composition.

Embodiment 2. The method of claim 1 wherein the saturated paraffinic process oil comprises saturates in an amount of at least 98 wt. %.

Embodiment 3. The method of claim 1 wherein the EPDM rubber comprises a polymerized product of ethylene monomer, propylene monomer, and one or more diene monomers.

Embodiment 4. The method of claim 3 wherein the one or more diene monomers comprise at least one monomer selected from the group consisting of 1,4-pentadiene, 1,4-hexadiene, 5-ethylidene-2-norbornene, dicyclopentadiene, cyclohexadiene, 5-butylidene-2-norbornene, and combinations thereof.

Embodiment 5. The method of claim 1 wherein the saturated paraffinic process oil has a ratio of terminal/pendant propyl groups to epsilon carbon atoms of at least 0.060.

Embodiment 6. The method of claim 1 wherein the saturated paraffinic process oil has a ratio of a sum of terminal/pendant propyl groups and terminal/pendant ethyl groups to epsilon carbon atoms of at least 0.10.

Embodiment 7. The method of claim 1 wherein the saturated paraffinic process oil has a kinematic viscosity at 100° C. of 28 cSt to 40 cSt.

Embodiment 8. The method of claim 1 wherein the EPDM composition further comprises an additional elastic copolymer comprising a polymerized product of at least two monomers selected from ethylene, propylene, 1-butene, 1-pentene, 1-hexene, 4-methyl-1-pentene, 1-octene, diene-containing monomers, and combinations thereof.

Embodiment 9. The method of claim 8 wherein the additional elastic copolymer comprises ethylene and propylene and wherein the EPDM article is a thermoplastic olefin.

Embodiment 10. The method of claim 1 wherein the EPDM composition further comprises a curing agent selected from the group consisting of 2,2′-Dithiobis(benzothiazole) (MBTS), 2-Mercaptobenzothiazole (MBT), zinc dibenzyldithiocarbamate (ZBEC), trimethylolpropane trimethacrylate (TMPTMA), and combinations thereof.

Embodiment 11. The method of claim 1 wherein the EPDM composition further comprises a curing agent selected from the group consisting of phenolic resin, peroxides, azides, aldehyde-amine reaction products, vinyl silane grafted moieties, hydrosilylation, substituted ureas, substituted guanidines; substituted xanthates; substituted dithiocarbamates; sulfur-containing compounds, such as thiazoles, imidazoles, sulfenamides, thiuramidisulfides, paraquinonedioxime, dibenzoparaquinonedioxime, sulfur, and combinations thereof.

Embodiment 12. The method of claim 1 wherein the EPDM composition comprises the saturated paraffinic process oil in an amount of about 1 wt. % to 50 wt. % by weight of the EPDM composition.

Embodiment 13. A composition comprising: cured EPDM; and a saturated paraffinic process oil having: a kinematic viscosity at 100° C. of at least 14 cSt; a sulfur content of less than 0.03 wt. %;
a saturates content of at least 90 wt. %; a T5 distillation point of at least 480° C.; an aniline point in a range of about 130° C. to about 150° C.; a refractive index at 20° C. in a range of 1.470-1.490; and a sum of terminal/pendant propyl groups and terminal/pendant ethyl groups of at least 1.7 per 100 carbon atoms of the composition.

Embodiment 14. The composition of claim 13 wherein the saturated paraffinic process oil has a ratio of terminal/pendant propyl groups to epsilon carbon atoms of at least 0.060.

Embodiment 15. The composition of claim 13 wherein the saturated paraffinic process oil has a ratio of a sum of terminal/pendant propyl groups and terminal/pendant ethyl groups to epsilon carbon atoms of at least 0.10.

Embodiment 16. The composition of claim 13 wherein the saturated paraffinic process oil has a kinematic viscosity at 100° C. of 28 cSt to 40 cSt.

Embodiment 17. The composition of claim 13 wherein the rubber composition has at least the following properties: a ratio of R to R₀ of at least 80%, has no formation of crystalline deposits, and has no formation of oily film when tested according to SAE J 1756: 2006, Photometric Method.

Embodiment 18. The composition of claim 13 wherein the rubber composition has at least the following properties: a ratio of R to R₀ of at least 50%, has no formation of crystalline deposits, and has no formation of oily film when tested according to SAE J 1756: 2006, Photometric Method.

Embodiment 19. The composition of claim 13 further comprising at least one additive selected from the group consisting of carbon black, amorphous precipitated or fumed silica, titanium dioxide, polyethylene glycol, calcium oxide, magnesium oxide, colored pigments, clay, talc, calcium carbonate, magnesium carbonate, aluminum silicates, wollastonite, mica, montmorillonite, glass beads, hollow glass spheres, glass fibers, plastic fibers, zinc oxide, stearic acid and salts thereof, wax, wood cellulose fibers, and combinations thereof.

Embodiment 20. A method comprising: polymerizing ethylene, propylene, and a diene containing monomer to form ethylene-propylene-diene-monomer (EPDM) rubber; and mixing the EPDM rubber with a saturated paraffinic process oil, wherein the saturated paraffinic process oil has: a kinematic viscosity at 100° C. of at least 14 cSt; a sulfur content of less than 0.03 wt. %; a saturates content of at least 90 wt. %; a T5 distillation point of at least 480° C.; an aniline point in a range of about 130° C. to about 150° C.; a refractive index at 20° C. in a range of 1.470-1.490; and a sum of terminal/pendant propyl groups and terminal/pendant ethyl groups of at least 1.7 per 100 carbon atoms of the composition.

Embodiment 21. The method of claim 23 wherein the saturated paraffinic process oil has a ratio of terminal/pendant propyl groups to epsilon carbon atoms of at least 0.060;

Embodiment 22. The method of claim 23 wherein the saturated paraffinic process oil has a ratio of a sum of terminal/pendant propyl groups and terminal/pendant ethyl groups to epsilon carbon atoms of at least 0.10.

Embodiment 23. The method of claim 23 wherein the saturated paraffinic process oil has a T50 distillation point of at least 1000° F. (538° C.) and a T90 distillation point of at least 1150° F. (621° C.).

To facilitate a better understanding of the embodiments of the present invention, the following examples of preferred or representative embodiments are given. In no way should the following examples be read to limit, or to define, the scope of the invention.

### Example 1

In this example, a variety of rheological and physical tests were performed on sulfur cured EPDM rubber compounds using three different process oils. The 3 comparative compounds made were typical weather seal rubber and under hood hose as well as roofing material. Conventionally these classes of compounds are manufactured using a conventional high viscosity paraffinic process oil.

The three process oils include a conventional high viscosity paraffinic process oil, a saturated mid-viscosity paraffinic process oil, and a saturated high viscosity paraffinic process oil. The three process oils used were analyzed and the results of the analysis are shown in Table 2.

TABLE 2

| | Kinematic | Aromatic | Naphthenic | Paraffinic | | |
|---|---|---|---|---|---|---|
| | Viscosity at | Carbons | Carbons | Carbons | Aniline | Refractive |
| Process oil Type | 100° C. (cSt) | (CA) (%) | (CN) (%) | (CP) (%) | Point (° C.) | Index |
| conventional high | 31.5 | 7.2 | 26.1 | 66.7 | 119.4 | 1.496 |
| viscosity paraffinic | | | | | | |
| process oil | | | | | | |
| saturated mid- | 11.9 | 0 | 26.9 | 73.1 | 128.3 | 1.475 |
| viscosity paraffinic | | | | | | |
| process oil | | | | | | |
| saturated high | 33.9 | 0 | 25.9 | 74.1 | 142.4 | 1.482 |
| viscosity paraffinic | | | | | | |
| process oil | | | | | | |

Three EPDM master batch compositions were prepared according to the formulation in Table 3, where each of the values are shown in grams. Each of the EPDM master compositions were prepared with different process oils from Table 2. The EPDM rubber used was a terpolymer with a high diene content. The EPDM rubber had a Mooney viscosity ML (1+4 at 125° C.) (ASTM D1646) of 78, ethylene weight % (ASTM D3900) of 63 wt. %, ethylidene norbornene weight % (ASTM D6047) of 8.0 wt. %, with a bimodal molecular weight distribution, and provided as a semi-dense bale. The three master batch compositions were prepared with carbon black, calcium carbonate, the process oil, zinc oxide, stearic acid, polyethylene glycol with a number average molecular weight of 4000, and calcium oxide. Each of the EPDM master batch compositions were blended in a mixer until uniform.

TABLE 3
Master Batch - Sulfur Cured

| | conventional | saturated mid- | saturated high |
|---|---|---|---|
| | high viscosity | viscosity | viscosity |
| | paraffinic | paraffinic | paraffinic |
| Compound | process oil | process oil | process oil |
| EPDM Rubber | 100.00 | 100.00 | 100.00 |
| Carbon Black | 130.00 | 130.00 | 130.00 |
| CaCo3 | 30.00 | 30.00 | 30.00 |
| Process Oil | 60.00 | 60.00 | 60.00 |
| ZnO (Zinc oxide) | 4.00 | 4.00 | 4.00 |
| Stearic Acid | 1.00 | 1.00 | 1.00 |
| PEG - 4000 | 3.00 | 3.00 | 3.00 |
| Calcium Oxide | 7.00 | 7.00 | 7.00 |
| Total Master Batch | 335.00 | 335.00 | 335.00 |

After mixing each of the EPDM master batch compositions, each of the EPDM master batch compositions was mixed with a curing package in a mixer as shown in Table 4 to form the final EPDM compositions. The curing package included sulfur, 2,2′-Dithiobis(benzothiazole) (MBTS), 2-Mercaptobenzothiazole (MBT), zinc dibenzyldithiocarbamate (ZBEC), a first accelerator including an elastomer binder and accelerators of the thiazole and thiuram class as well as sulfur, a second accelerator including an elastomer binder and accelerators of the thiazole and thiuram class as well as sulfur, and a retarder. Each of the EPDM compositions was subjected to physical and chemical tests to measure the performance of the EPDM compositions produced with the different process oils.

TABLE 4
Final Batch - Sulfur Cured

| | conventional | saturated mid- | saturated high |
|---|---|---|---|
| | high viscosity | viscosity | viscosity |
| | paraffinic | paraffinic | paraffinic |
| Compound | process oil | process oil | process oil |
| Total Master Batch | 335.00 | 335.00 | 335.00 |
| Sulfur | 1.00 | 1.00 | 1.00 |
| MBTS | 1.00 | 1.00 | 1.00 |
| MBT | 0.50 | 0.50 | 0.50 |
| ZBEC | 0.70 | 0.70 | 0.70 |
| Accelerator 1 | 1.50 | 1.50 | 1.50 |
| Accelerator 2 | 1.10 | 1.10 | 1.10 |
| Retarder | 0.20 | 0.20 | 0.20 |
| Total Phr lab* | 341.00 | 341.00 | 341.00 |
| % Polymer content | 29 | 29 | 29 |

*Phr—Parts per 100 parts of rubber

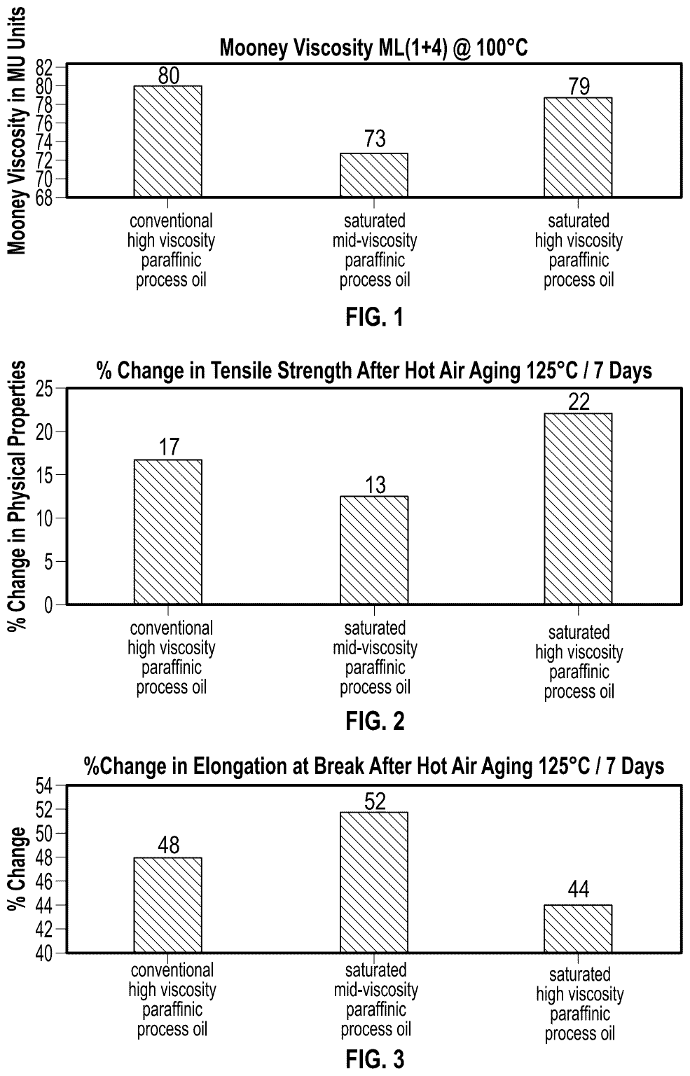

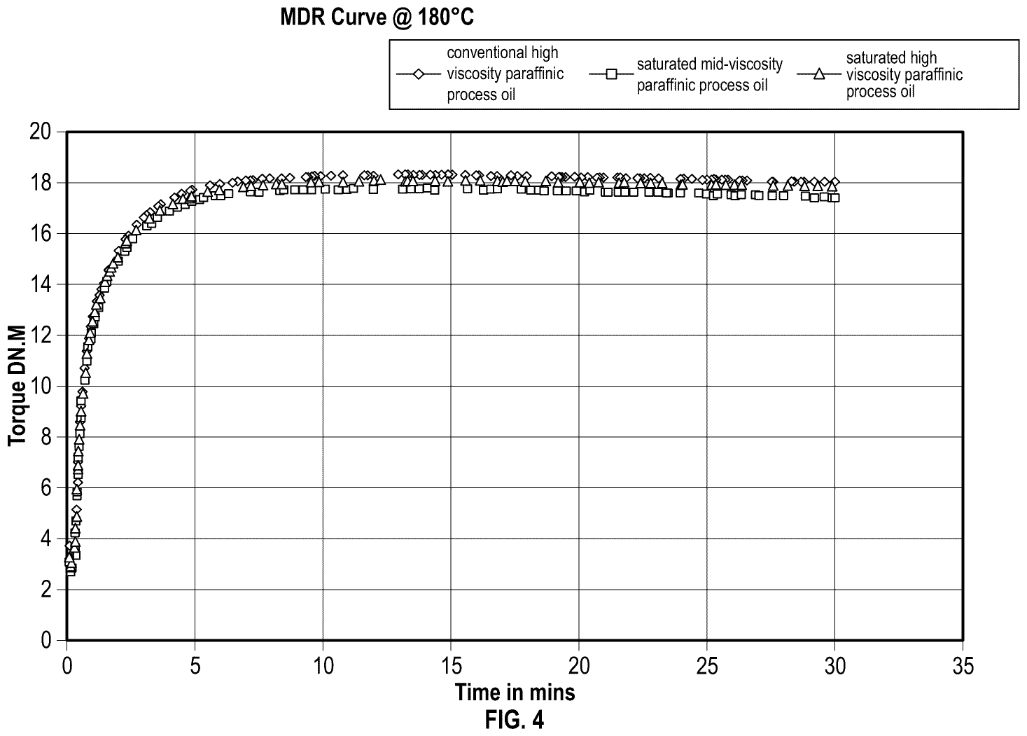

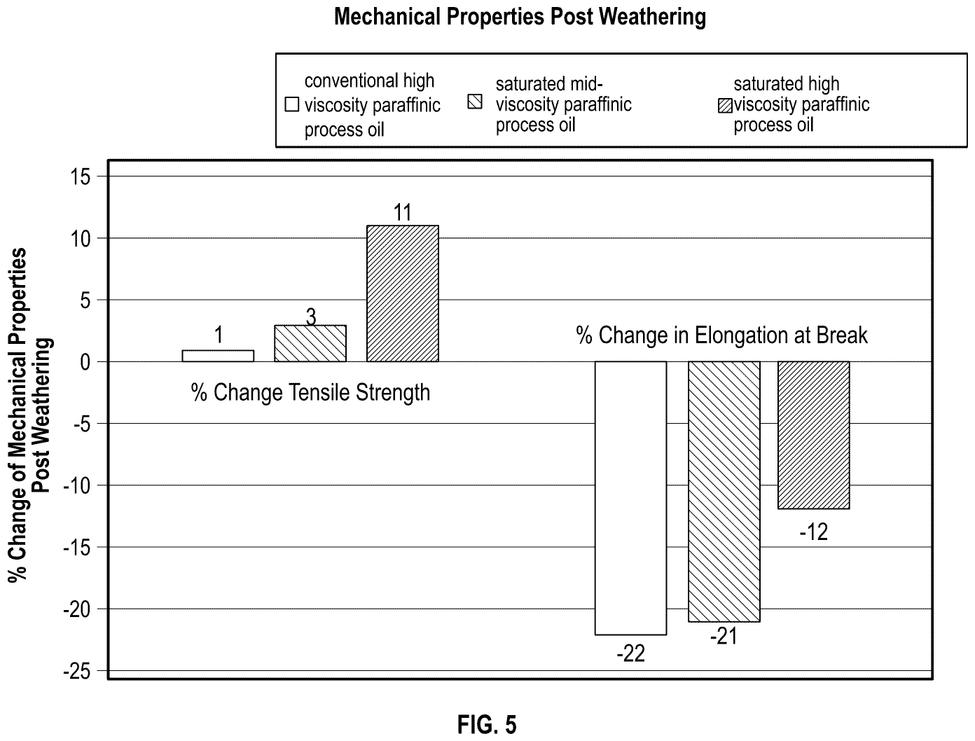

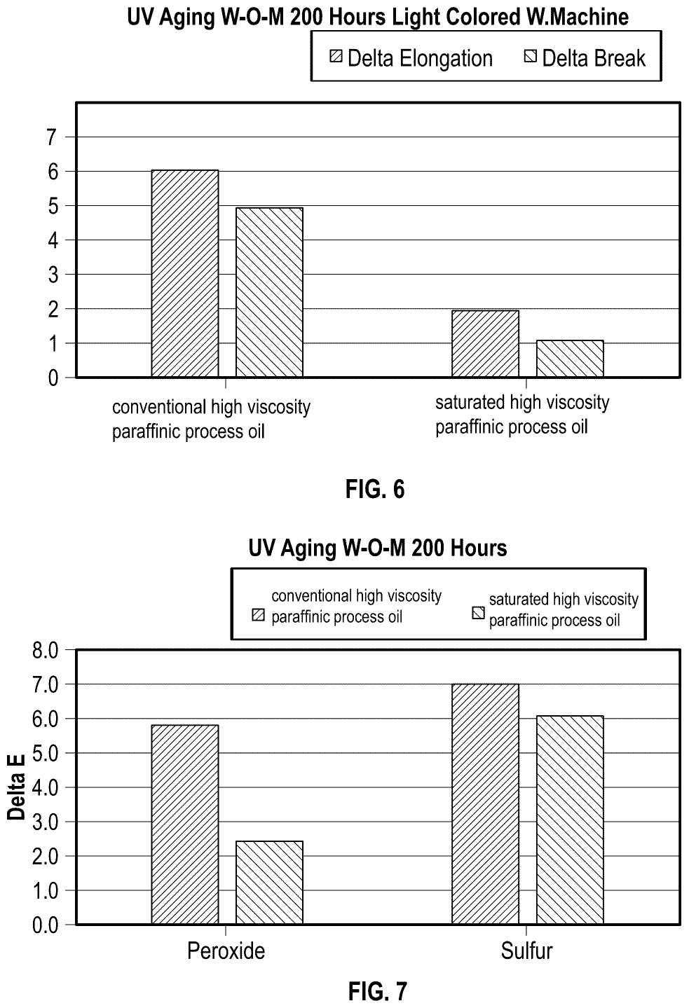

Each of the EPDM compositions was tested to determine physical and chemical properties. Mooney viscosity, Mooney scorch, moving die rheometer (MDR) testing, hardness, mechanical properties after compounding and mechanical properties after the EPDM composition after hot aging for 7 days at 125° C., weathering tests in accordance with SAE J2527_201709, compression set in accordance with ASTM D395-18, and fogging test in accordance with SAE J 1756: 2006, Photometric Method. The results of the testing are shown in Table 5. FIG. 1 is a graph of results of Mooney Viscosity for the EPDM compositions. It was observed that the saturated mid viscosity paraffinic process oil produced the lowest Mooney viscosity and the saturated high viscosity paraffinic process oil produced a Mooney viscosity similar to conventional high viscosity paraffinic process oil. FIG. 2 is a graph of results of tensile strength test after hot air aging for the EPDM compositions. It was observed that the saturated mid viscosity paraffinic process oil produced the lowest change in tensile strength and saturated high viscosity paraffinic process oil produced a Mooney viscosity with a greater change as compared to conventional high viscosity paraffinic process oil. FIG. 3 is a graph of results of change in elongation at break after hot air aging for the EPDM compositions. It was observed that the saturated mid viscosity paraffinic process oil produced the greatest change in elongation at break and the saturated high viscosity paraffinic process oil produced the least amount of change in elongation at break. FIG. 4 is an MDR curve of the EPDM compositions. It was observed that the torque for the conventional high viscosity paraffinic process oil was the highest while the saturated mid-viscosity paraffinic process oil process the lowest torque. The difference in torque is due to the difference in cross link density due to the presence of aromatic compounds in the conventional high viscosity paraffinic process oil. FIG. 5 is a graph of results of change in mechanical properties of change in tensile strength and elongation at break. It was observed that the tensile strength of the EPDM composition produced with the saturated high viscosity paraffinic process oil had the greatest change in strength and the least change in elongation at break. FIG. 6 is a graph of results of UV aging in a weatherometer (W-O-M) in accordance with SAE J2527_201709 to measure the change in elongation and change in break. FIG. 7 is a graph of results of UV aging in a weatherometer (W-O-M) of the EPDM compositions. The results of the UV aging tests for the EPDM compositions cured with sulfur are further shown in Table 6. It was observed that the conventional high viscosity paraffinic process oil produced a EPDM composition which yellowed compared to the EPDM composition produced with saturated mid and high viscosity paraffinic process oils.

TABLE 5

| | | | | |
|---|---|---|---|---|
| | | conventional | saturated mid- | saturated high |
| | | high viscosity | viscosity | viscosity |
| | | paraffinic | paraffinic | paraffinic |
| Parameter | unit | process oil | process oil | process oil |

Mooney Viscosity ML (1 + 4) @ 100° C.

| | | | | |
|---|---|---|---|---|
| ML(1 + 4) | [MU] | 80 | 73 | 79 |

Mooney Scorch ML(1 + 60) @ 125° C.

| | | | | |
|---|---|---|---|---|
| T2 | [min] | 3.7 | 3.7 | 3.8 |
| T5 | [min] | 4.4 | 4.3 | 4.5 |

MDR 160° C. / 60 mins

| | | | | |
|---|---|---|---|---|
| ML | [dNM] | 3.1 | 2.6 | 3 |
| MH | [dNM] | 18.4 | 17.9 | 18.2 |
| MH-ML | [dNM] | 15.3 | 15.3 | 15.2 |
| TS2 | [min] | 0.4 | 0.4 | 0.4 |
| TC90 | [min] | 3.2 | 3.2 | 3.2 |

Hardness

| | | | | |
|---|---|---|---|---|
| Original | Shore A | 72 | 71 | 72 |
| Hot air aged 125° C. / 7 days | Shore A | 80 | 81 | 79 |
| Change in hardness | Shore A | 8 | 10 | 7 |

Mechanical Properties - Original

| | | | | |
|---|---|---|---|---|
| Modulus at 100% | Mpa | 5.1 | 4.7 | 5 |
| Modulus at 200% | MPa | 9.6 | 8.8 | 9.5 |
| Tensile Strength at Break | MPa | 12.2 | 11.9 | 11.6 |
| Elongation at Break | % | 270 | 290 | 250 |
| Energy at Break | [J] | 5.5 | 6.1 | 5 |

Mechanical Properties - Hot air aged 125° C. / 7 days

| | | | | |
|---|---|---|---|---|
| Modulus at 100% | Mpa | 10.1 | 10.2 | 10.3 |
| Tensile Strength at Break | MPa | 14.2 | 13.4 | 14.2 |
| Elongation at Break | % | 140 | 140 | 140 |
| Energy at Break | [J] | 3.4 | 3 | 3.2 |
| Change in Tensile | % | 17 | 13 | 22 |
| Change in Energy at Break | % | −48 | −52 | −44 |

Mechanical Properties - Post Accelerated weathering test post SAE J2527

| | | | | |
|---|---|---|---|---|
| Modulus at 100% | Mpa | 6.5 | 6.2 | 6.7 |
| Tensile Strength at Break | MPa | 12.3 | 12.3 | 12.9 |
| Elongation at Break | % | 210 | 230 | 220 |
| Energy at Break | [J] | 4.4 | 4.9 | 4.9 |
| Change in Tensile | % | 1 | 3 | 11 |
| Change in Energy at Break | % | −22 | −21 | −12 |

Mechanical Properties - Compression Set / 25% Compression

| | | | | |
|---|---|---|---|---|
| Compression Set | % | 35 | 33 | 35 |

Fogging Test - SAE J 1756: 2006, Photometric Method

| | | | | |
|---|---|---|---|---|
| Ratio of R to R0 | % | — | 85.3 | 84.5 |

TABLE 6

| | conventional | saturated mid- | saturated high |
|---|---|---|---|
| | high viscosity | viscosity | viscosity |
| | paraffinic | paraffinic | paraffinic |
| Oil Type | process oil | process oil | process oil |
| Absorption | Strong >> 400 | Light, in UV | Light in UV band |
| At 400 nm | | | |
| t*Original | 0.7 | 0.15 | 0.25 |
| *60 hours | 1.5 | 0.15 | 0.2 |
| Color change | Yellow | stable | stable |

It was observed from the testing that saturated mid-viscosity paraffinic process oil and saturated high viscosity paraffinic process oil in sulfur cured EPDM compositions improves clarity and resistance to discoloration compared to conventional high viscosity paraffinic process oil in fogging test SAE J 1756 which is critical for automobile exterior parts. Further the saturated high viscosity paraffinic process oil compounds demonstrated better mechanical properties including tensile strength, % EB retention after accelerated weathering exposure based on SAE J2527 than conventional high viscosity paraffinic process oil which indicates better retention properties post weathering exposure which is critical for weather seal applications. The UV aging data further indicated better color stability observed post UV aging with saturated paraffinic process oils as compared to conventional high viscosity paraffinic process oil. Improved color stability is typically a requirement in light colored EPDM products. Saturated high viscosity paraffinic process oil compounds demonstrated better mechanical properties including tensile strength and % EB after hot air aging than conventional high viscosity paraffinic process oil which indicates better aging retention properties.

FIGS. 1-4 and Table 5 shows all the 3 process oil compounds have similar rheological & physical properties which shows substituting process oil in EPDM based Sulfur cured weather seal formulation does not greatly impact processing, rheological, and other original physical properties.

### Example 2

In this example, a variety of rheological and physical tests were performed on peroxide cured EPDM rubber compounds, using three different process oils. The 3 comparative compounds made were typical under hood hose material. Currently, these classes of compounds are typically manufactured using a conventional high viscosity paraffinic process oil.

Three EPDM master batch compositions were prepared according to the formulation in Table 7, where each of the values are shown in grams. Each of the EPDM master compositions were prepared with different process oils from Table 2. The EPDM rubber used was a terpolymer with a medium diene content. The EPDM had a Mooney viscosity ML (1+4 at 125° C.) (ASTM D1646) of 60, ethylene weight % (ASTM D3900) of 69 wt. %, ethylidene norbornene weight % (ASTM D6047) of 2.8 wt. %. The ethylene propylene (EP) copolymer had a Mooney viscosity ML (1+4 at 125° C.) (ASTM D1646) of 42 and ethylene weight % (ASTM D3900) of 65 wt. %. The three master batch compositions were prepared with two grades of carbon black, calcined clay, magnesium oxide, a first antioxidant comprising polymerized 1,2-dihydro-2,2,4-trimethylquinoline (TMQ), a second antioxidant comprising zinc 2-mercaptotolumidazole (ZMTI), and the process oil. Each of the EPDM master batch compositions were blended in a mixer until uniform.

TABLE 7
Master Batch - Peroxide Cured

| | conventional | Saturated mid- | Saturated high |
|---|---|---|---|
| | high viscosity | viscosity | viscosity |
| | paraffinic | paraffinic | paraffinic |
| Compound | process oil | process oil | process oil |
| EPDM | 20.00 | 20.00 | 20.00 |
| EP Copolymer | 80.00 | 80.00 | 80.00 |
| Carbon Black 1 | 45.00 | 45.00 | 45.00 |
| Carbon Black 2 | 15.0 | 15.0 | 15.0 |
| Calcined clay | 35.0 | 35.0 | 35.0 |
| MgO | 5.0 | 5.0 | 5.0 |
| TMQ | 1.0 | 1.0 | 1.0 |
| ZMTI | 2.0 | 2.0 | 2.0 |
| Process Oil | 35.00 | 35.00 | 35.00 |
| Total Master | 238.00 | 238.00 | 238.00 |
| Batch | | | |

After mixing each of the EPDM master batch compositions, each of the EPDM master batch compositions was mixed with a curing package as shown in Table 8 to form the final EPDM compositions. The curing package included trimethylolpropane trimethacrylate (TMPTMA) and 2,2′-Dithiobis(benzothiazole) (MBTS). Each of the peroxide cured EPDM compositions was subjected to physical and chemical tests to measure the performance of the EPDM compositions produced with the different process oils.

TABLE 8
Final Batch - Peroxide Cured

| | conventional | saturated mid- | saturated high |
|---|---|---|---|
| | high viscosity | viscosity | viscosity |
| | paraffinic | paraffinic | paraffinic |
| Compound | process oil | process oil | process oil |
| Total Master | 238.00 | 238.00 | 238.00 |
| Batch | | | |
| TMPTMA | 1.5 | 1.5 | 1.5 |
| MBTS | 9.0 | 9.0 | 9.0 |
| Total Final Batch | 248.50 | 248.50 | 248.50 |
| % Polymer | 29 | 29 | 29 |
| content | | | |

Each of the peroxide cured EPDM compositions was tested to determine physical and chemical properties. Mooney viscosity, Mooney scorch, moving die rheometer (MDR) testing, hardness, mechanical properties after compounding and mechanical properties after the EPDM composition after hot aging for 28 and 42 days at 150° C., weathering tests in accordance with SAE J2527_201709, compression set in accordance with ASTM D395-18, and fogging test in accordance with SAE J 1756: 2006, Photometric Method. The results of the testing are shown in Table 9.

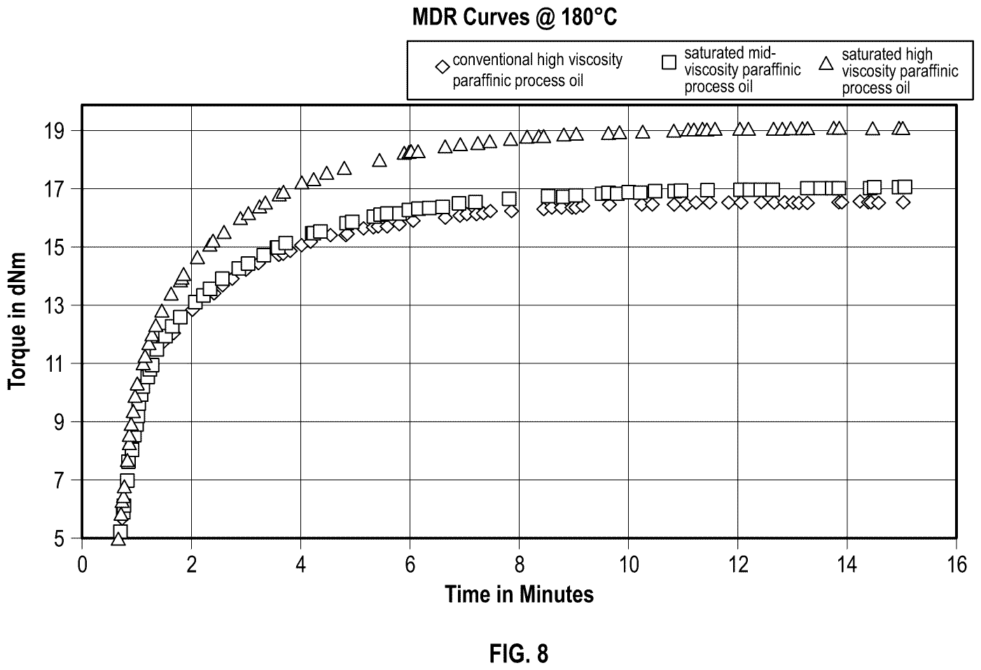

FIG. 8 is an MDR curve of the EPDM compositions. It was observed that the torque for saturated high viscosity paraffinic process oil was the highest while conventional high viscosity paraffinic process oil had the lowest torque. The difference in torque is due to the difference in cross link density due to the presence of aromatic compounds in the conventional high viscosity paraffinic process oil.

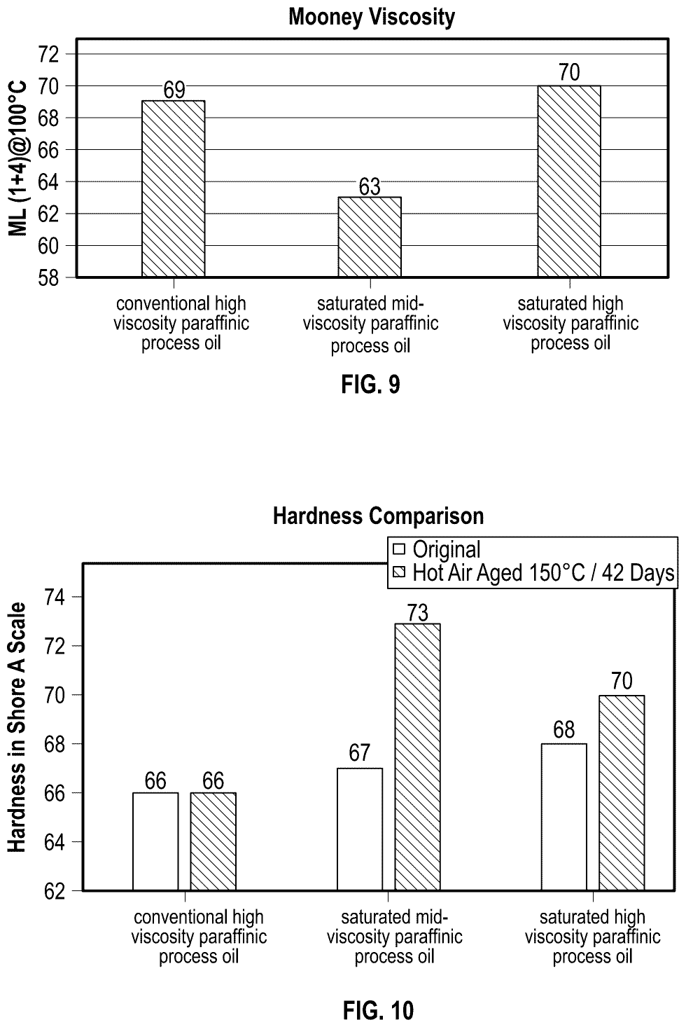

FIG. 9 is a is a graph of results of Mooney Viscosity for the peroxide cured EPDM compositions. It was observed that the saturated mid viscosity paraffinic process oil produced the lowest Mooney viscosity and the saturated high viscosity paraffinic process oil produced the highest Mooney viscosity similar to conventional high viscosity paraffinic process oil.

FIG. 10 is a graph of hardness in Shore A scale for the original EPDM compositions and Shore A hardness after hot air aging for 42 days at 150° C. It was observed that the hardness increased in the EPDM compositions produced with paraffinic process oils after hot air aging.

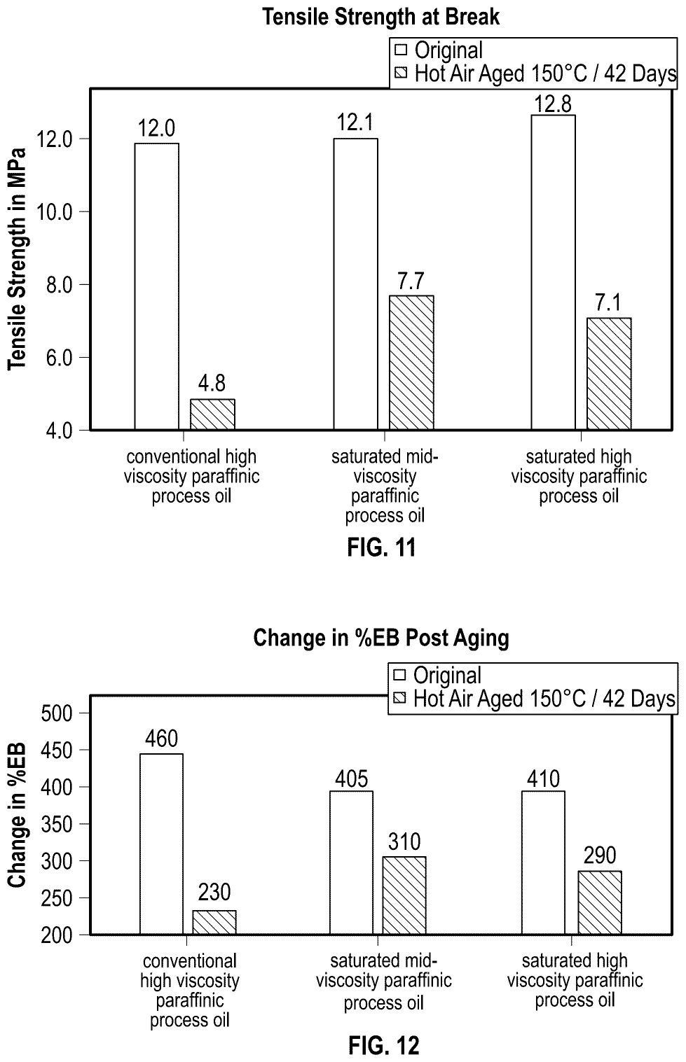

FIG. 11 is a graph of tensile strength at break for original EPDM compositions and after hot air aging for 42 days at 150° C. It was observed that the tensile strength of the EPDM compositions produced with saturated mid-viscosity paraffinic process oil and saturated high viscosity paraffinic process oil retained greater tensile strength after hot air aging as compared to the EPDM composition produced with the conventional high viscosity paraffinic process oil.

FIG. 12 is a graph of the change in elongation at breaking for original EPDM compositions and after hot air aging for 42 days at 150° C. It was observed that the EPDM compositions produced with the saturated mid-viscosity paraffinic process oil and saturated high viscosity paraffinic process oil retained greater elasticity strength after hot air aging as compared to the EPDM composition produced with the conventional high viscosity paraffinic process oil.

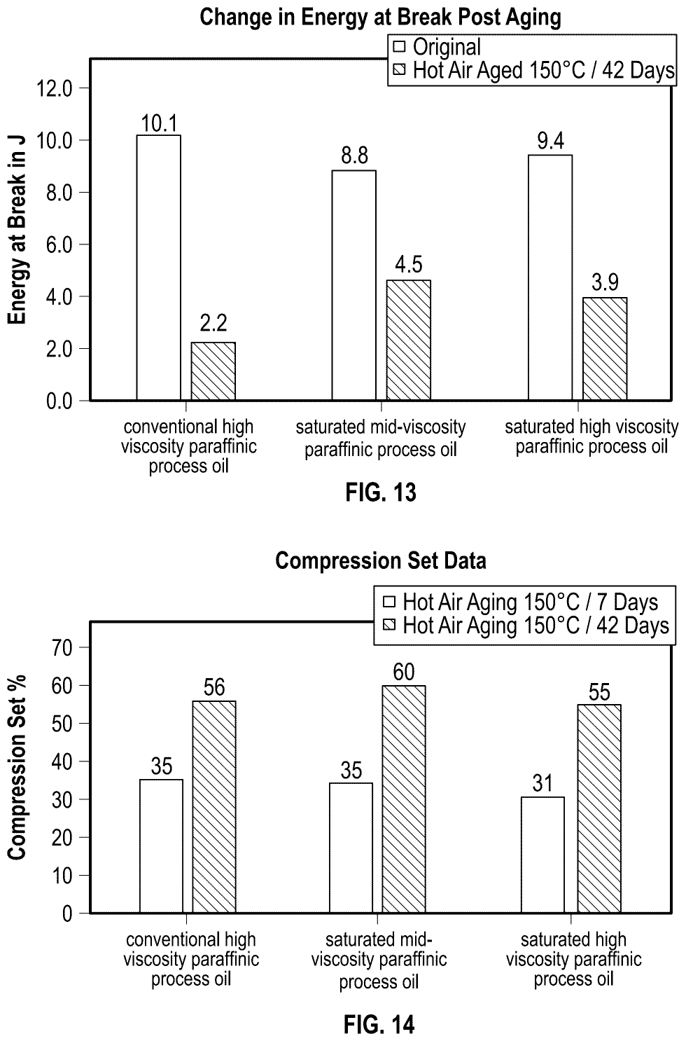

FIG. 13 is a graph of the change in energy at breaking for original EPDM compositions and after hot air aging for 42 days at 150° C. Additionally, it was observed that the EPDM compositions produced with saturated mid-viscosity paraffinic process oil and saturated high viscosity paraffinic process oil retained greater higher energy at breaking after hot air aging as compared to the EPDM composition produced with the conventional high viscosity paraffinic process oil.

FIG. 14 is a graph of the change in compression hot air aged EPDM compositions for 7 and 42 days at 150° C. It was observed that the EPDM compositions produced with saturated mid-viscosity paraffinic process oil and saturated high viscosity paraffinic process oil produced similar compression results to EPDM compositions produced with conventional high viscosity process oil.

TABLE 9

| | | | | |
|---|---|---|---|---|
| | | conventional | saturated mid- | saturated high |
| | | high viscosity | viscosity | viscosity |
| | | paraffinic | paraffinic | paraffinic |
| Parameter | unit | process oil | process oil | process oil |

Mooney Viscosity ML (1 + 4) @ 100° C.

| | | | | |
|---|---|---|---|---|
| ML(1 + 4) | [MU] | 69 | 63 | 70 |

Mooney Scorch ML(1 + 60) @ 125° C.

| | | | | |
|---|---|---|---|---|
| T2 | [min] | 8.5 | 8.3 | 8.4 |
| T5 | [min] | 9.4 | 9 | 9.1 |

MDR 160° C. / 60 mins

| | | | | |
|---|---|---|---|---|
| ML | [dNM] | 1.5 | 1.4 | 1.5 |
| MH | [dNM] | 17.4 | 17.9 | 19.1 |
| MH-ML | [dNM] | 15.9 | 16.5 | 17.6 |
| TS2 | [min] | 0.5 | 0.5 | 0.5 |
| T50 | [min] | 1 | 1 | 1 |
| TC90 | [min] | 4.1 | 4.2 | 4.2 |

Hardness

| | | | | |
|---|---|---|---|---|
| Original | Shore A | 66 | 67 | 68 |
| Hot air aged 125° C. / 42 days | Shore A | 66 | 73 | 70 |
| Change in hardness | Shore A | 0 | 6 | 2 |

Mechanical Properties - Original

| | | | | |
|---|---|---|---|---|
| Modulus at 100% | Mpa | 3.2 | 3.5 | 3.6 |
| Modulus at 200% | MPa | 6.1 | 6.6 | 6.9 |
| Modulus at 300% | MPa | 8.6 | 9.4 | 9.8 |
| Tensile Strength at Break | MPa | 12 | 12.1 | 12.8 |
| Elongation at Break | % | 460 | 405 | 410 |
| Energy at Break | [J] | 10.1 | 8.8 | 9.4 |

Mechanical Properties - Hot air aged 150° C. / 28 days

| | | | | |
|---|---|---|---|---|
| Modulus at 100% | Mpa | 3.2 | 4.1 | 3.8 |
| Modulus at 200% | Mpa | 6.1 | 7.4 | 7.1 |
| Modulus at 300% | Mpa | 8.3 | 10 | 9.8 |
| Tensile Strength at Break | MPa | 9.8 | 10.7 | 11 |
| Elongation at Break | % | 3990 | 330 | 360 |
| Energy at Break | [J] | 7.2 | 6.5 | 7.2 |
| Change in Tensile | % | −18 | −12 | −14 |
| Change in Energy at Break | % | −15 | −19 | −12 |

Mechanical Properties - Hot air aged 150° C. / 42 days

| | | | | |
|---|---|---|---|---|
| Modulus at 100% | Mpa | 2.5 | 3.2 | 2.9 |
| Modulus at 200% | Mpa | 4.5 | 5.7 | 5.3 |
| Modulus at 300% | Mpa | — | 7.9 | — |
| Tensile Strength at Break | MPa | 4.8 | 7.7 | 7.1 |
| Elongation at Break | % | 230 | 310 | 290 |
| Energy at Break | [J] | 2.2 | 4.5 | 3.9 |
| Change in Tensile | % | −60 | −36 | −44 |
| Change in Energy at Break | % | −50 | −23 | −29 |

Mechanical Properties - Compression Set / 25% Compression

| | | | | |
|---|---|---|---|---|
| Hot air aged 150° C. / 7 days | | | | |
| Hot air aged 150° C. / 42 days | % | 35 | 33 | 35 |

Fogging Test - SAE J 1756: 2006, Photometric Method

| | | | | |
|---|---|---|---|---|
| Ratio of R to RO | % | — | 69 | 56.5 |

In rheology graph FIG. 8, saturated high viscosity paraffinic process oil in EPDM based peroxide cure demonstrated better heat resistant properties as well as better cure rate and cross link density than conventional high viscosity paraffinic process oil. This is primarily due to presence of aromatic compounds in the conventional high viscosity paraffinic process oil which interfere in peroxide vulcanization by absorbing active free radicals which reduces crosslinking efficiency. Better elastic and mechanical properties can be achieved with saturated high viscosity paraffinic process oil at similar level of peroxide dosage compared to conventional high viscosity paraffinic process oil. It was further observed from the rheology graph with saturated paraffinic process oils in peroxide cure formulation, the saturated paraffinic process oil can reduce peroxide dosage thereby saving in cost to achieve similar crosslink density and mechanical properties performance of compounds with conventional high viscosity paraffinic process oil. Better mechanical properties including hardness, tensile strength, % elongation at break, and energy at break, retention post long-term hot air aging (150° C. @42 days) with saturated paraffinic process oil EPDM compounds compared to conventional high viscosity paraffinic process oil which are critical as under hood hoses face continuous exposure to high temperatures up to 150° C.

Slightly Better compression set is observed with saturated high viscosity paraffinic process oil compounds compared to conventional high viscosity paraffinic process oil due to better elasticity and cross link density compared to conventional high viscosity paraffinic process oil such as in FIG. 10. From Table 9 data, fogging data as per SAE J 2524 indicates better fogging resistance for compounds with saturated high viscosity paraffinic process oils due to lower volatility.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A method for using a saturated paraffinic process oil comprising:
curing an elastomer composition to form a cured rubber article, wherein the elastomer composition comprises an elastomer and a saturated paraffinic process oil, wherein the saturated paraffinic process oil comprises:
a kinematic viscosity at 100° C. in a range of 14 cSt to 45 cSt;
a sulfur content of less than 0.03 wt. %;
a saturates content of at least 90 wt. %;
a T5 distillation point of at least 480° C.;
an aniline point in a range of about 130° C. to about 150° C.;
a refractive index at 20° C. in a range of 1.460-1.490; and
a sum of terminal/pendant propyl groups and terminal/pendant ethyl groups of at least 1.7 per 100 carbon atoms of the composition.

2. The method of claim 1 wherein the saturated paraffinic process oil comprises saturates in an amount of at least 98 wt. %.

3. The method of claim 1 wherein the elastomer comprises at least one elastomer selected from the group consisting of olefinic elastomeric copolymers, butyl rubber, natural rubber, styrene-butadiene copolymer rubber, butadiene rubber, acrylonitrile rubber, butadiene-styrene-vinyl pyridine rubber, urethane rubber, polyisoprene rubber, epichlorohydrin terpolymer rubber, polychloroprene, and combinations thereof.

4. The method of claim 1 wherein the elastomer comprises an EPDM rubber comprising a polymerized product of ethylene monomer, propylene monomer, and one or more diene monomers.

5. The method of claim 4 wherein the one or more diene monomers comprise at least one monomer selected from the group consisting of 1,4-pentadiene, 1,4-hexadiene, 5-ethylidene-2-norbornene, dicyclopentadiene, cyclohexadiene, 5-butylidene-2-norbornene, and combinations thereof.

6. The method of claim 1 wherein the saturated paraffinic process oil has a ratio of terminal/pendant propyl groups to epsilon carbon atoms of at least 0.060.

7. The method of claim 1 wherein the saturated paraffinic process oil has a ratio of a sum of terminal/pendant propyl groups and terminal/pendant ethyl groups to epsilon carbon atoms of at least 0.10.

8. The method of claim 1 wherein the saturated paraffinic process oil has a kinematic viscosity at 100° C. of 28 cSt to 40 cSt.

9. The method of claim 1 wherein the EPDM composition further comprises a curing agent selected from the group consisting of 2,2′-Dithiobis(benzothiazole) (MBTS), 2-Mercaptobenzothiazole (MBT), zinc dibenzyldithiocarbamate (ZBEC), trimethylolpropane trimethacrylate (TMPTMA), and combinations thereof.

10. The method of claim 1 wherein the EPDM composition further comprises a curing agent selected from the group consisting of phenolic resin, peroxides, azides, aldehyde-amine reaction products, vinyl silane grafted moieties, hydrosilylation, substituted ureas, substituted guanidines; substituted xanthates; substituted dithiocarbamates; sulfur-containing compounds, such as thiazoles, imidazoles, sulfenamides, thiuramidisulfides, paraquinonedioxime, dibenzoparaquinonedioxime, sulfur, and combinations thereof.

11. The method of claim 1 wherein the elastomer composition comprises the saturated paraffinic process oil in an amount of about 1 wt. % to 50 wt. % by weight of the elastomer composition.

12. The method of claim 1 wherein the cured rubber article comprises at least one article selected from the group consisting of automotive body parts, tires, hoses, belts, gaskets, moldings, molded parts, and combinations thereof.

13. An elastomer composition comprising:
an elastomer; and
a saturated paraffinic process oil having:
a kinematic viscosity at 100° C. of at least 14 cSt;
a sulfur content of less than 0.03 wt. %;
a saturates content of at least 90 wt. %;
a T5 distillation point of at least 480° C.;
an aniline point in a range of about 130° C. to about 150° C.;
a refractive index at 20° C. in a range of 1.470-1.490; and
a sum of terminal/pendant propyl groups and terminal/pendant ethyl groups of at least 1.7 per 100 carbon atoms of the composition.

14. The elastomer composition of claim 13 wherein the elastomer comprises at least one elastomer selected from the group consisting of olefinic elastomeric copolymers, butyl rubber, natural rubber, styrene-butadiene copolymer rubber, butadiene rubber, acrylonitrile rubber, EPDM rubber, butadiene-styrene-vinyl pyridine rubber, urethane rubber, polyisoprene rubber, epichlorohydrin terpolymer rubber, polychloroprene, and combinations thereof.

15. The composition of claim 13 wherein the saturated paraffinic process oil has a ratio of terminal/pendant propyl groups to epsilon carbon atoms of at least 0.060.

16. The composition of claim 13 wherein the saturated paraffinic process oil has a ratio of a sum of terminal/pendant propyl groups and terminal/pendant ethyl groups to epsilon carbon atoms of at least 0.10.

17. The composition of claim 13 wherein the saturated paraffinic process oil has a kinematic viscosity at 100° C. of 28 cSt to 40 cSt.

18. The composition of claim 13 wherein the rubber composition has at least the following properties: a ratio of R to R₀ of at least 80%, has no formation of crystalline deposits, and has no formation of oily film when tested according to SAE J 1756: 2006, Photometric Method.

19. The composition of claim 13 wherein the rubber composition has at least the following properties: a ratio of R to R₀ of at least 50%, has no formation of crystalline deposits, and has no formation of oily film when tested according to SAE J 1756: 2006, Photometric Method.

20. The composition of claim 13 further comprising at least one additive selected from the group consisting of carbon black, amorphous precipitated or fumed silica, titanium dioxide, polyethylene glycol, calcium oxide, magnesium oxide, colored pigments, clay, talc, calcium carbonate, magnesium carbonate, aluminum silicates, wollastonite, mica, montmorillonite, glass beads, hollow glass spheres, glass fibers, plastic fibers, zinc oxide, stearic acid and salts thereof, wax, wood cellulose fibers, and combinations thereof.

21. A method comprising:
polymerizing ethylene, propylene, and a diene containing monomer to form ethylene-propylene-diene-monomer (EPDM) rubber; and
mixing the EPDM rubber with a saturated paraffinic process oil, wherein the saturated paraffinic process oil has:
a kinematic viscosity at 100° C. of at least 14 cSt;
a sulfur content of less than 0.03 wt. %;
a saturates content of at least 90 wt. %;
a T5 distillation point of at least 480° C.;
an aniline point in a range of about 130° C. to about 150° C.;
a refractive index at 20° C. in a range of 1.470-1.490; and
a sum of terminal/pendant propyl groups and terminal/pendant ethyl groups of at least 1.7 per 100 carbon atoms of the composition.

22. The method of claim 21 wherein the saturated paraffinic process oil has a ratio of terminal/pendant propyl groups to epsilon carbon atoms of at least 0.060.

23. The method of claim 21 wherein the saturated paraffinic process oil has a ratio of a sum of terminal/pendant propyl groups and terminal/pendant ethyl groups to epsilon carbon atoms of at least 0.10.

24. The method of claim 21 wherein the saturated paraffinic process oil has a T50 distillation point of at least 1000° F. (538° C.) and a T90 distillation point of at least 1150° F. (621° C.).
